(19) United States
(12) Patent Application Publication
(10) Pub. No.: US 2016/0110348 A1
(43) Pub. Date: Apr. 21, 2016

(54) Computer Based Translation System and Method

(71) Applicant: Alibek Issaev, Dubai (AE)

(72) Inventor: Alibek Issaev, Dubai (AE)

(21) Appl. No.: 14/878,532

(22) Filed: Oct. 8, 2015

Related U.S. Application Data
(60) Provisional application No. 62/061,498, filed on Oct. 8, 2014.

(51) Int. Cl. G06F 17/28; G10L 15/26; H04M 3/53; H04L 29/06; H04L 29/08; G10L 13/00; H04L 12/58

(52) U.S. Cl. CPC G06F 17/289; G10L 13/00; G10L 15/26; H04L 51/04; H04L 67/42; H04L 67/10; H04M 3/5322

(57) ABSTRACT

A computer based system and method for translation and communication of messages includes sending a message in a source language using a transmission protocol from a first client device to a second client device. The source language message is transmitted using a transmission protocol to a translation server for translating the message from the source language to a destination language by either the first or second client device. The message, in its destination language form, is displayed and stored. The translation server is either on-line or off-line. Text-to-voice and voice-to-text converters are used for conversion of original text messages to voice, or of original voice to text, for transmission to the second client device.

### CROSS REFERENCE

The present nonprovisional application hereby claims the priority benefit of U.S. Provisional Application No. 62/061,498 filed on Oct. 8, 2014, the contents of which is hereby incorporated by reference in its entirety.

### FIELD OF THE INVENTION

The present invention relates generally to the field of machine or computer based translation systems and methods, and more particularly to systems and methods for providing application services, cloud based, on text-based and voice-based messaging and translation. This provides a multilingual system with the ability to translate and convert text-to-voice text in all directions between all languages. As used herein, “translation” is intended to mean a conversion of the meaning of an expression or word in one language to the same meaning in another language.

### BACKGROUND OF THE INVENTION

Text-based & voice-based messaging is a method of communication whereby textual character strings and voice recordings can be sent and received as translated messages. Messages can be exchanged between people in order to communicate information. Various types and configurations of computer based translation and/or conversion systems and methods have been known in the art. One such example for translation is described in international application WO 2015/145259, published Oct. 1, 2015, the contents of which is hereby incorporated by reference in its entirety. As illustrated and described in WO 2015/145259 a computer system is employed for effecting translations. Similarly, in the present invention a translation system is used. Further, U.S. published application 2013/000359, published on Jan. 3, 2013, which is hereby incorporated in its entirety by reference, describes and illustrates one type of computer based communication system and method. Other similar systems and methods are known in the art. Such a system is the type employed in the present invention for facilitating and effecting to inventions herein.

### SUMMARY OF THE INVENTION

The invention provides for a system and method of authorizing and registering a message, whether voice or text, from a first client for translation and transmission to a second client, with a server, translating the message and providing the translated message to the second client. A computer based system and method of the invention includes sending a message in a source language using a transmission protocol from a first client device to a second client device. The source language message is transmitted using a transmission protocol to a translation server for translating the message from the source language to a destination language by either the first or second client device. The message, in its destination language form, is displayed and stored. The translation server is either on-line or off-line. Text-to-voice and voice-to-text converters are used for conversion of original text messages to voice, or of original voice to text, for transmission to the second client device.

### BRIEF DESCRIPTION OF THE DRAWINGS

The invention will be described in connection with exemplary embodiments illustrated in the annexed drawings, in which:

FIGS. 1(a) and 1(b) are respectively: a schematic diagram of system elements; and a flow diagram illustrating process steps, for a text-to-text communication sequence between two devices with an embedded offline translation system (translation server) used in an example embodiment of the present invention;

FIGS. 2(a) and 2(b) are respectively: a schematic diagram of system elements; and a flow diagram illustrating process steps, for a text-to-text communication sequence between two devices with a cloud-based translation system used in an example embodiment of the present invention;

FIGS. 3(a) and 3(b) are respectively: a schematic diagram of system elements; and a flow diagram illustrating process steps, for a text-to-voice communication sequence between two devices with an embedded offline translation system, offline voice-to-text converter and offline text-to-voice converter used in an example embodiment of the present invention;

FIGS. 4(a) and 4(b) are respectively: a schematic diagram of system elements; and a flow diagram illustrating process steps, for a text-to-voice communication sequence between two devices with an embedded offline, translation system, cloud-based voice-to-text converter and cloud-based text-to-voice converter used in an example embodiment of the present invention;

FIGS. 5(a) and 5(b) are respectively: a schematic diagram of system elements; and a flow diagram illustrating process steps, for a text-to-voice communication sequence between two devices with an embedded cloud-based translation system, offline voice-to-text converter and offline text-to-voice converter used in an example embodiment of the present invention;

FIGS. 6(a) and 6(b) are respectively: a schematic diagram of system elements; and a flow diagram illustrating process steps, for a text-to-voice communication sequence between two devices with an embedded cloud-based translation system, cloud-based voice-to-text converter and cloud-based text-to-voice converter used in an example embodiment of the present invention;

FIGS. 7(a) and 7(b) are respectively: a schematic diagram of system elements; and a flow diagram illustrating process steps, for a voice-to-text communication sequence between two devices with an embedded offline translation system, offline voice-to-text converter and offline text-to-voice converter used in an example embodiment of the present invention;

FIGS. 8(a) and 8(b) are respectively: a schematic diagram of system elements; and a flow diagram illustrating process steps, for a voice-to-text communication sequence between two devices with an embedded offline translation system, cloud-based voice-to-text converter and cloud-based text-to-voice converter used in an example embodiment of the present invention.

FIGS. 9(a) and 9(b) are respectively: a schematic diagram of system elements; and a flow diagram illustrating process steps, for a voice-to-text communication sequence between two devices with an embedded cloud-based translation system, offline voice-to-text converter and offline text-to-voice converter used in an example embodiment of the present invention;

FIGS. 10(a) and 10(b) are respectively: a schematic diagram of system elements; and a flow diagram illustrating process steps, for a voice-to-text communication sequence between two devices with an embedded cloud-based translation system, cloud-based voice-to-text converter and cloud-based text-to-voice converter used in an example embodiment of the present invention;

FIGS. 11(a) and 11(b) are respectively: a schematic diagram of system elements; and a flow diagram illustrating process steps, for voice-to-voice communication sequence between two devices with an embedded offline translation system, offline voice-to-text converter and offline text-to-voice converter used in an example embodiment of the present invention;

FIGS. 12(a) and 12(b) are respectively: a schematic diagram of system elements; and a flow diagram illustrating process steps, for voice-to-voice communication sequence between two devices with an embedded offline translation system, cloud-based voice-to-text converter and cloud-based text-to-voice converter used in an example embodiment of the present invention;

FIGS. 13(a) and 13(b) are respectively: a schematic diagram of system elements; and a flow diagram illustrating process steps, for voice-to-voice communication sequence between two devices with an embedded cloud-based translation system, offline voice-to-text converter and offline text-to-voice converter used in an example embodiment of the present invention;

FIGS. 14(a) and 14(b) are respectively: a schematic diagram of system elements; and a flow diagram illustrating process steps, for voice-to-voice communication sequence between two devices with an embedded cloud-based translation system, cloud-based voice-to-text converter and cloud-based text-to-voice converter used in an example embodiment of the present invention.

FIGS. 15(a) and 15(b) are respectively: a schematic diagram of system elements; and a flow diagram illustrating process steps, for authorization;

FIGS. 16(a) and 16(b) are respectively: a schematic diagram of system elements; and a flow diagram illustrating process steps, for registration;

FIGS. 17(a) and 17(b) are respectively: a schematic diagram of system elements; and a flow diagram illustrating process steps, for text message translation; and

FIGS. 18(a) and 18(b) are respectively: a schematic diagram of system elements; and a flow diagram illustrating process steps, for sending of voice messages.

### DETAILED DESCRIPTION OF THE EMBODIMENTS

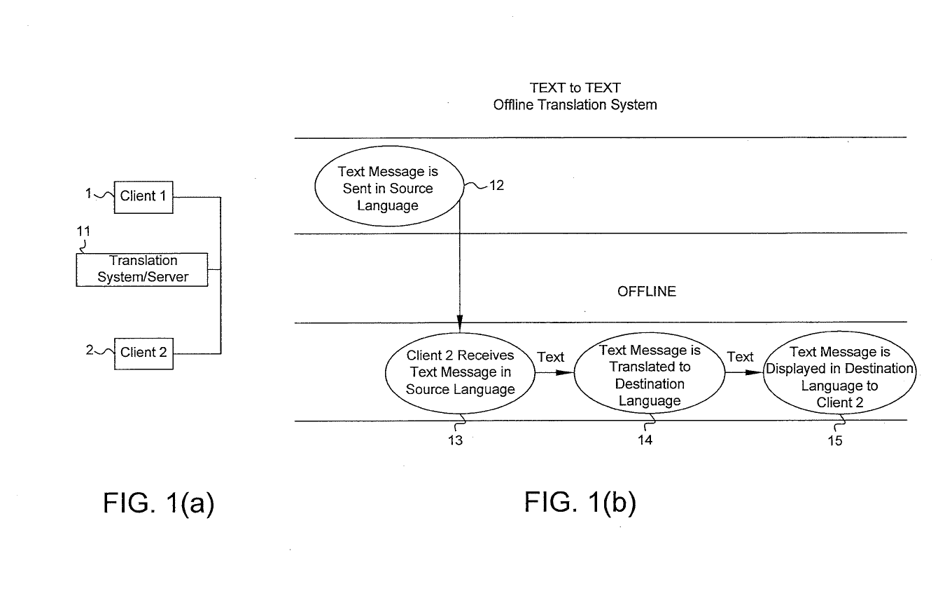

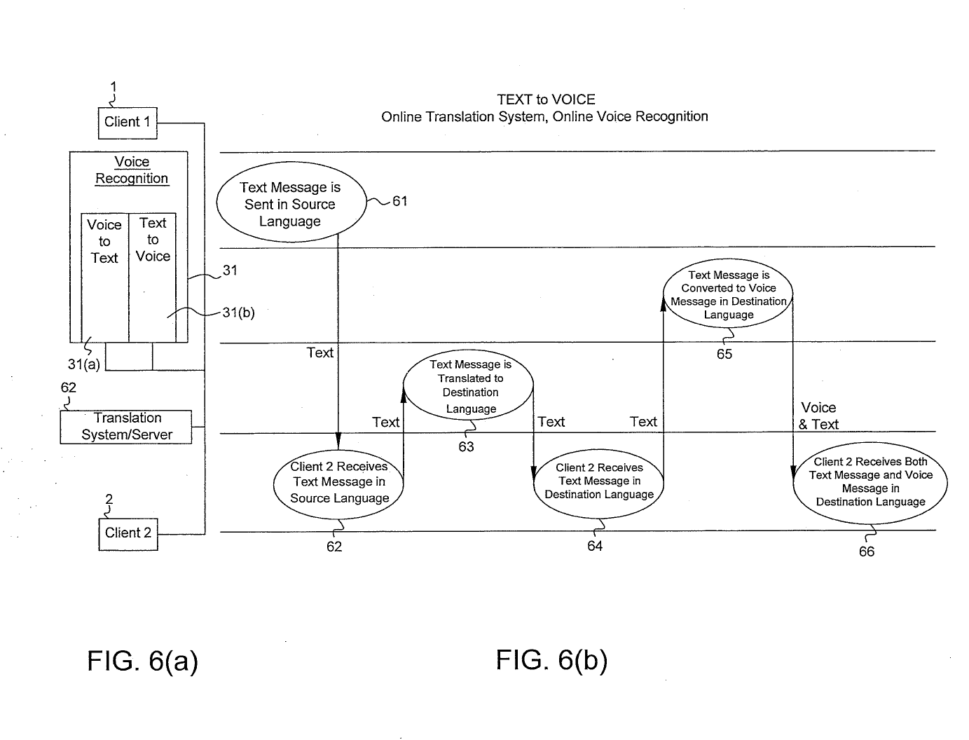

Referring now in more detail to the annexed drawings, FIGS. 1(a) and 1(b) through FIGS. 14(a) and 14(b) illustrate both system elements and process steps of various communication sequences as embodiments of the present invention.

Turning now specifically to FIG. 1(a) there is shown system elements for communication between a first client 1, sending a message, and a second client 2, receiving the message, through a translation system (translation server) 11.

FIG. 1(b) illustrates the process of a text to text message transmission/communication from client 1 to client 2 with an off-line translation system. At step 12, client device 1 sends a message in the original source language to client device 2, which receives the message in the original source language at step 13. Client 2 then transmits the text message to a translation system off-line at step 14 and the text is then transmitted back to client 2 for display in a destination language at step 15.

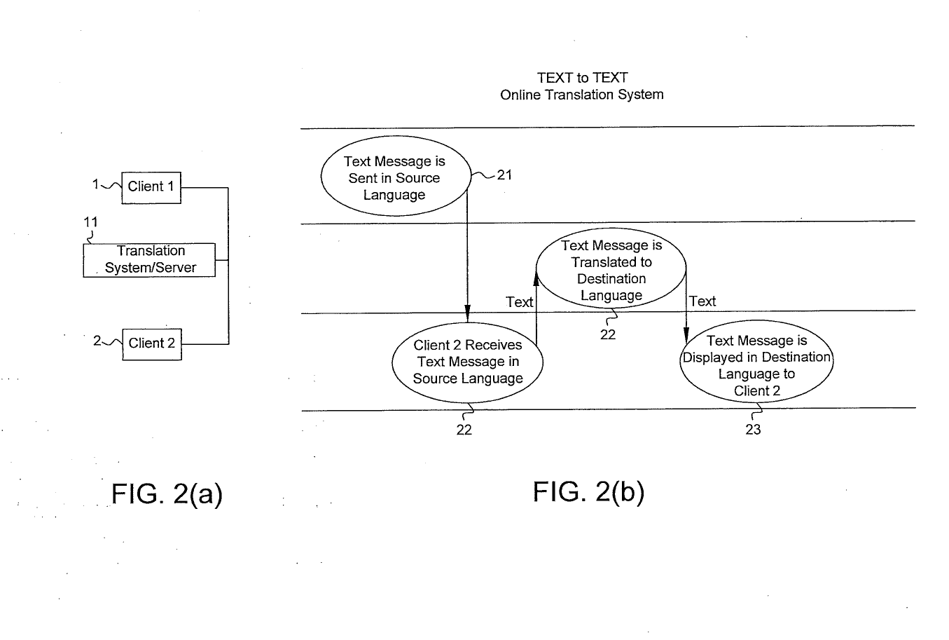

FIGS. 2(a) and 2(b) illustrate a similar text to text sequence translation and communication of a message from client 1 to client 2 with an online translation system. In FIG. 2(a), the same system elements as in FIG. 1(a) are illustrated. The process here, however, is different. At step 21, the client 1 sends the text message in the original source language to client 2 which receives it at step 22 in the original source language. Here, however, client 2 transmits the text message in its original source language to the translation system 11 where it is translated at step 23 into a destination language. After translation, the translated message in its destination language is transmitted to client 2 and displayed at step 23 in the destination language.

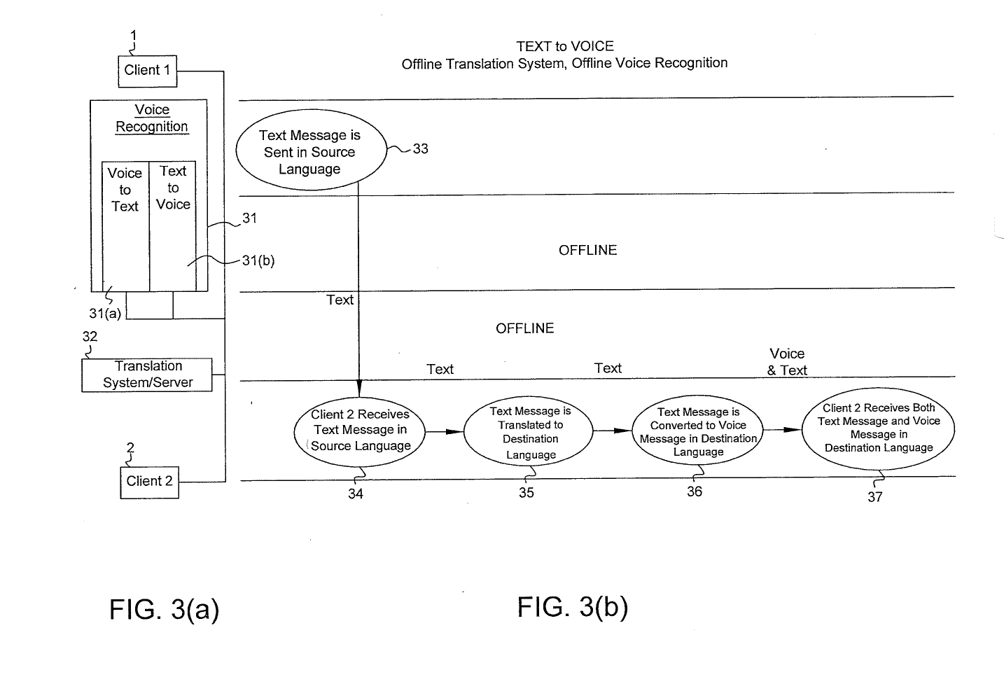

FIGS. 3(a) and 3(b) illustrate a sequence of text to voice transmission of a message with an off-line translation system and an off-line voice recognition system. At FIG. 3(a), system elements for client 1, a voice recognition system 31, a translation system 32, and client 2. Voice recognition system 31 includes voice-to-text converter 31(a) and text-to-text voice converter 31(b). The process here involves client 1 sending a text message at step 33, in its original source language, to client 2 which receives the message at step 34 in its original source language. Client 2 then transmits the text message to an off-line transmission system 32 at step 35 for translation. The text message, now in its destination language after translation, is then converted to a voice message in the destination language by text-to-voice converter 31(b) at step 36. At step 37, the client receives both the text message and the voice message in the destination language.

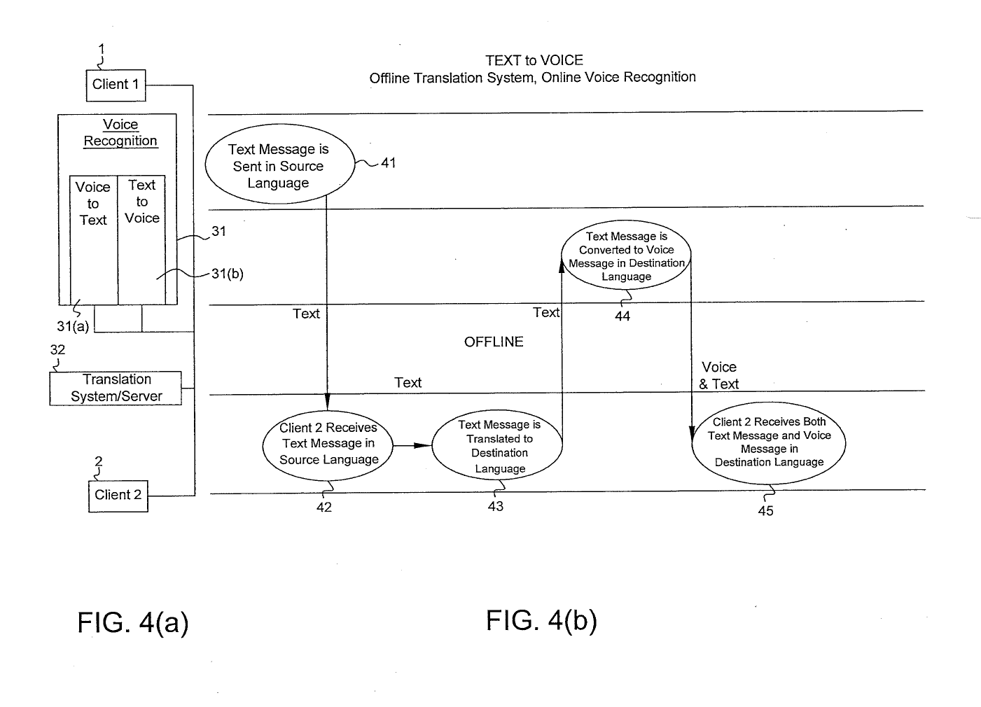

Turning now to FIGS. 4(a) and 4(b), another text to voice transmission sequence from client 1 to client 2 is illustrated. Here, the translation system is off-line, but the voice recognition system is online. Client 1 sends the text message in the original source language at step 41 to client 2. Client 2 receives the text message in the original source language at step 42 and transmits the message to the translation system 32, which translates the text message into the destination language and then transmits the text message in the destination language to voice recognition system 31 where, at step 44 it is converted to a voice message in the destination language by text-to-voice converter 31(b). The text and voice messages in the destination language are then transmitted to client 2 who receives both the text message and the voice message in the destination language at step 45.

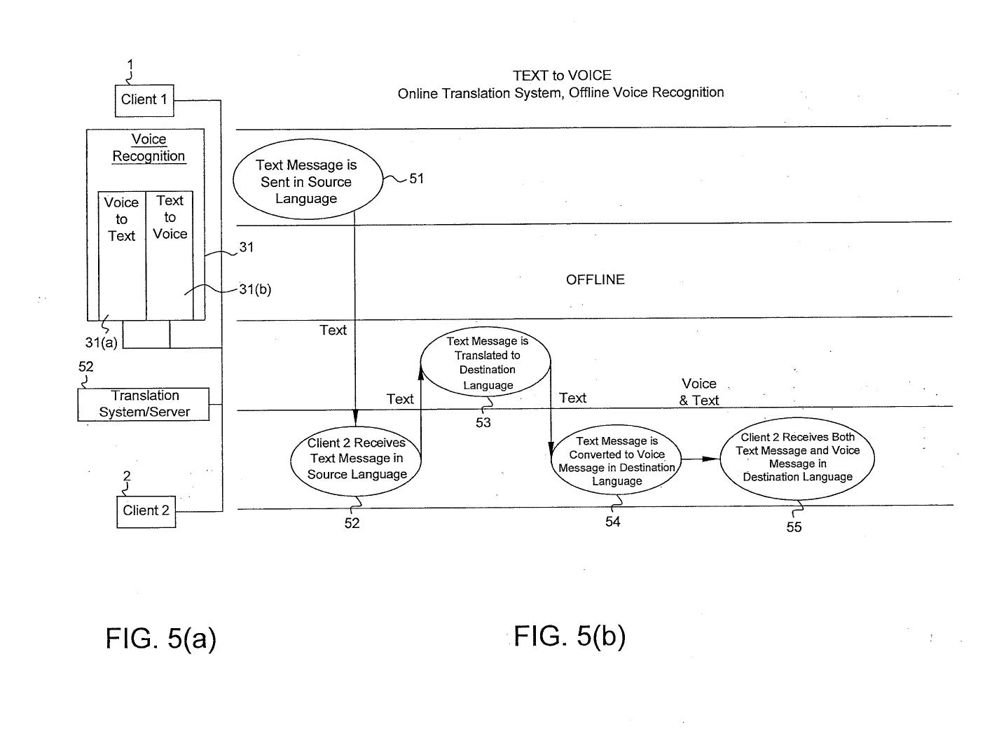

A further text to voice transmission sequence is illustrated in FIGS. 5(a) and 5(b). In this arrangement, the message is sent in the source language from the client 1 at step 51 to client 2, who receives it in the original source language at step 52. The message is then sent to an online translation system 52 where it is translated to the destination language at step 53. The destination language text is then forwarded to the voice recognition system 31, which is off-line, where it is converted at step 54 to a voice message in the destination language by the text-to-voice converter 31(b). From here, it is transmitted to client 2 which receives both the text and voice messages in the destination language at step 55.

A further text to voice translation sequence is illustrated in 6(a) and (b) where the text message, in its original source language, is transmitted at step 61 to client 2 who receives the message in its original source language at step 62. Client 2 transmits the text message in its original source language to the translation system 62, which is an online system, for translation at step 63 into the destination language. After translation at step 63, the text message now in its destination language, is transmitted back to client 2 which receives it in its destination language at step 64, and then transmits the text message in the destination language to online voice recognition system 31 where it is converted to a voice message in the destination language at step 65 by text-to-voice converter 31(b). The text and voice messages in the destination language are then transmitted to the client 2 who receives it at step 66.

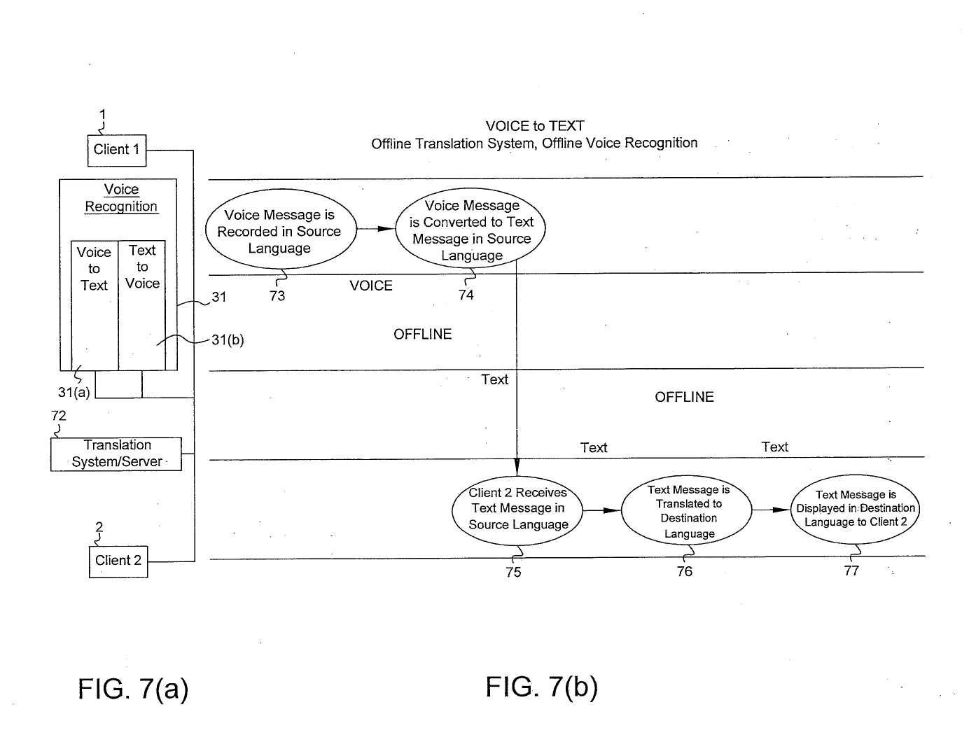

FIGS. 7(a) and 7(b) illustrate an off-line translation sequence with an off-line voice recognition system for transmitting a voice message from client 1 into a text message for delivery to client 2, Client 1 at step 73, records a voice message in the source language which is then transmitted for conversion to a text message by the voice-to-text converter 31(a) of voice recognition system 31 at step 74. The text message form is then transmitted to client 2 which receives it at step 75. The text message, still in its source language, is then translated by translation system 72, which is off-line, and the translated text message is then displayed at step 77 at client 2.

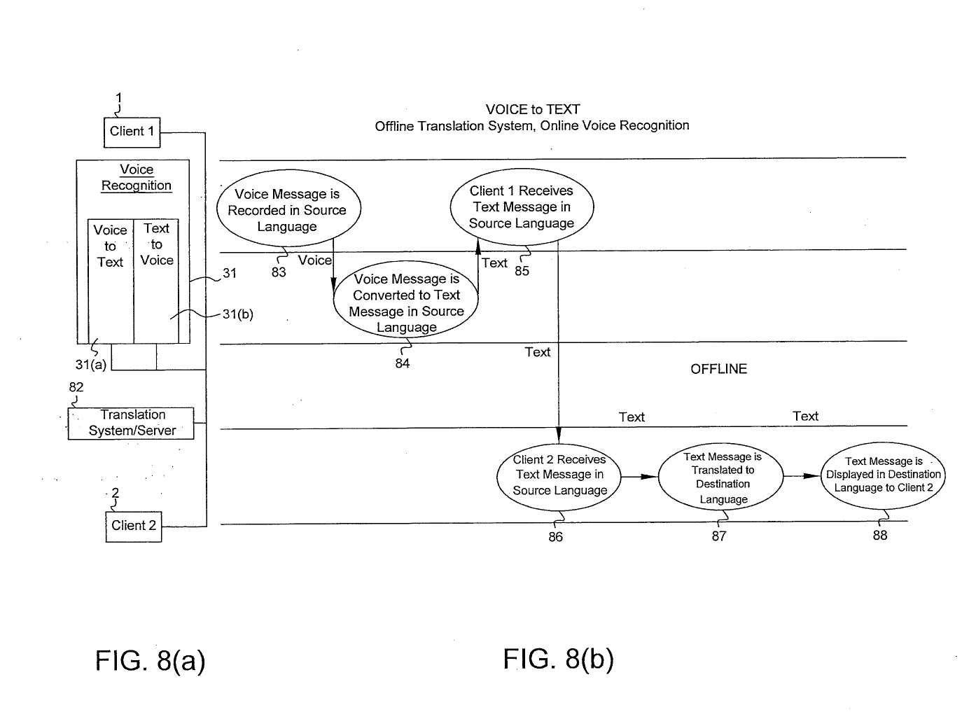

FIGS. 8(a) and 8(b) show client 1 recording a voice message in its source language at step 83 and which transmits the recorded message to online voice recognition system 31 where the voice message is converted by the voice-to-text converter 31(a) to a text message in the source language at step 84. The converted text message is transmitted to client 1 who receives it at step 85 in its original source language. Thereafter, the converted text message is transmitted to client 2 which receives it in its original source language at step 86, and who thereupon transmits it for translation to the off-line translation system 82 where, at step 87, the converted text message is translated to a text destination language. The text destination language is then transmitted to client 2 at step 88.

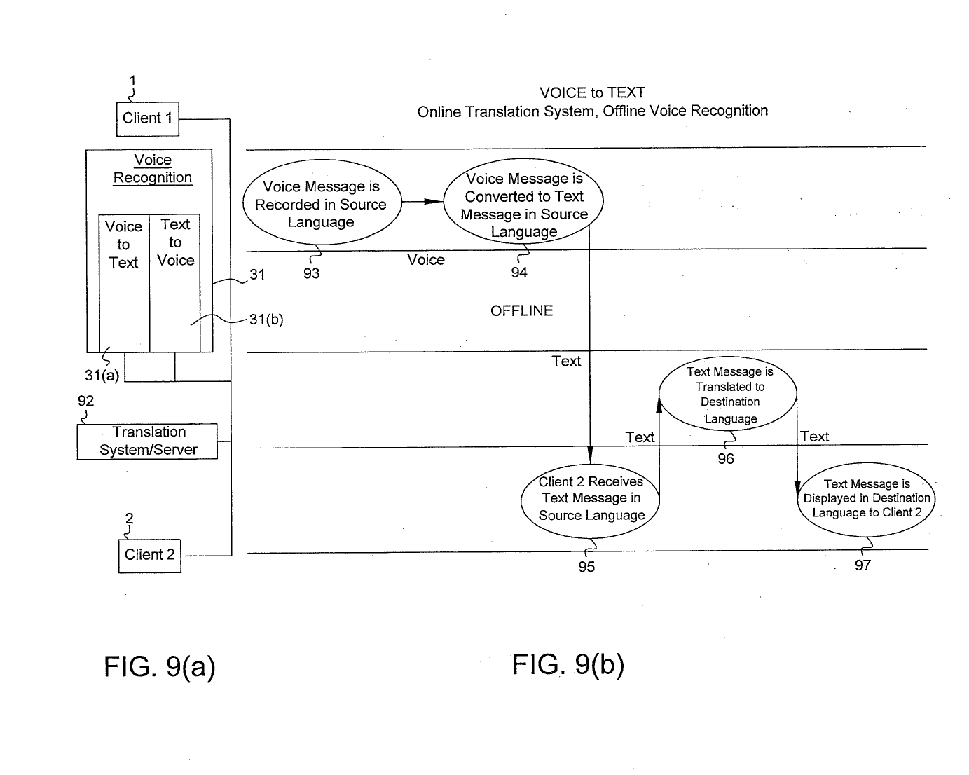

FIGS. 9(a) and 9(b) illustrate a sequence where client 1 records a voice message in a source language and transmits it to off-line voice recognition system 31 where at step 94 it is converted, by voice-to-text converter 31(a), to a text message in the source language. The converted text message is then transmitted to client 2 where it is received at step 95 and then transmitted to an online translation system 92 where the text message is translated to the destination language at step 96. The translated message in text form is then transmitted to client 2 where the translated text message is displayed in the destination language at step 97.

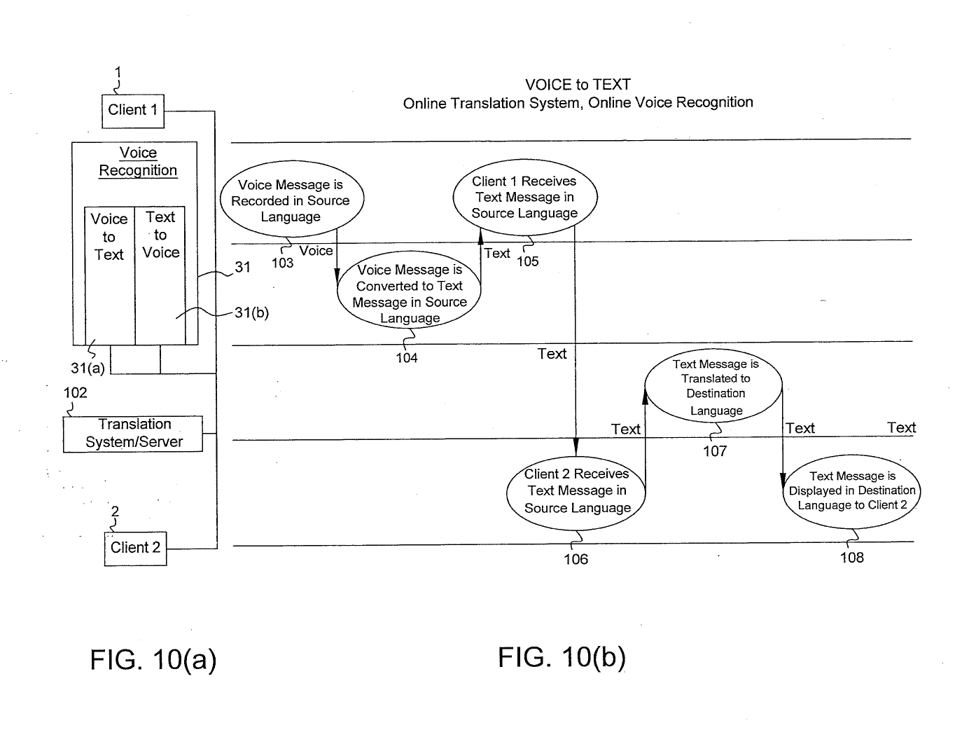

FIGS. 10(a) and 10(b) illustrate yet another voice to text translation sequence. Here, client 1 records a voice message in the source language and transmits it to online voice recognition system 31 where at step 104 the recorded voice message in the source language is converted by converter 31(a) to a text message in the same source language. The text message is then transmitted to client 1 who receives it at step 105 and transmits it to client 2 which receives it at step 106. The text message in the source language is then transmitted to the online translation system 102 where at step 107 the text message is translated into the destination language. Finally, the translated text message is transmitted to client 2 where at step 108 it is displayed in the destination language.

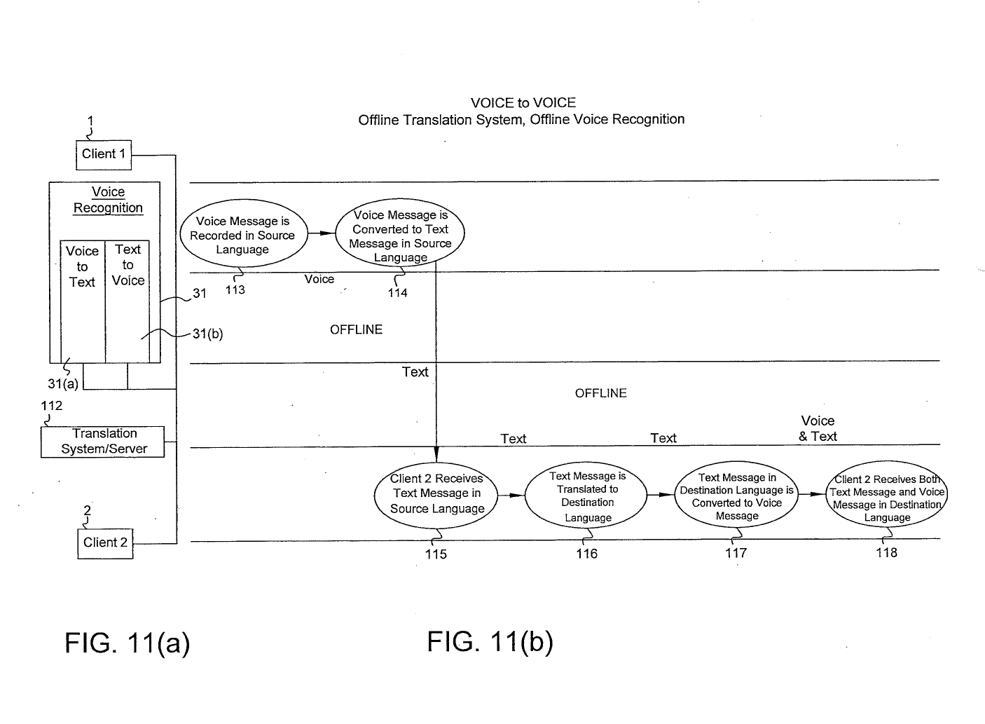

Yet another transmission sequence for a message from one client device to another, this time from voice to voice, is illustrated in FIG. 11. Client 1 records a voice message in a source language at step 113 and transmits that message to voice recognition system 31 where it is converted by converter 31(a) to a text message still in the source language at step 114. The converted message, now in text form, is transmitted to client 2, which receives it at step 115. The text message in the source language is then transmitted to the off-line translation system where it is translated into the destination language in text form at step 116. Step 117 is where the text message, now in the destination language, is converted by text-to-voice converter 31(b) of voice recognition system 31 into a voice message and transmits both the text message and the voice message in the destination language to client 2 who receives it at step 118.

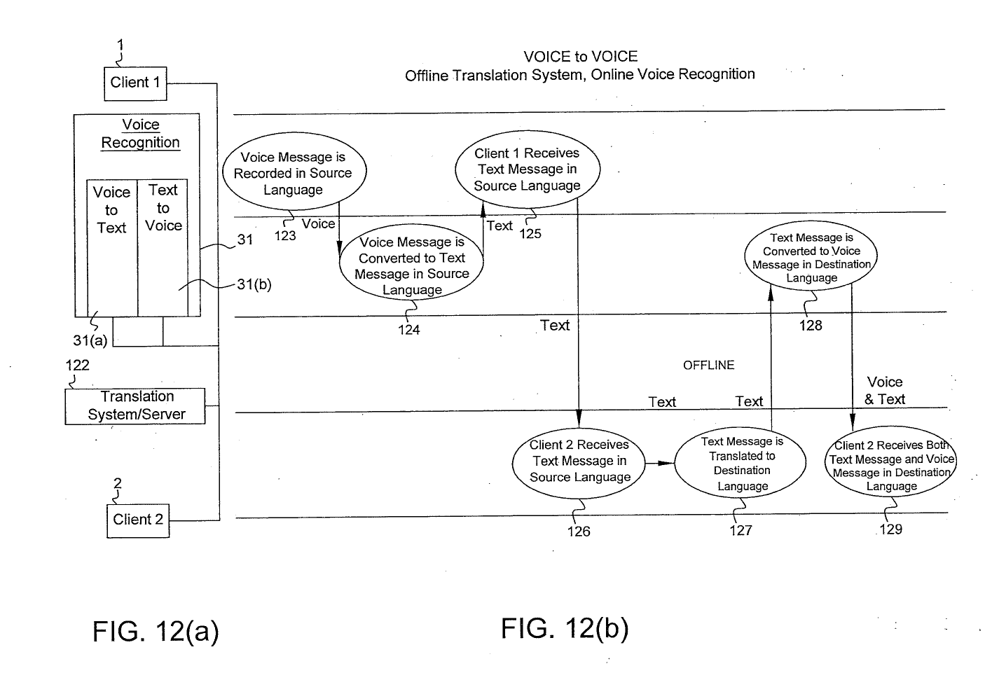

FIGS. 12(a) and 12(b) illustrate a voice to voice transmission sequence using on off-line translation system and an online voice recognition system. In this sequence client 1 records a voice message in the source language at step 123 and then transmits it to the converter 31(a) of voice recognition system 31 where, at step 124, it is converted to a text message in the source language. The text message in the source language is then transmitted from the voice recognition system 121 back to client 1 who receives it at step 125. The text message in the source language is then transmitted to client 2 which receives it at step 126 and then transmits it to the translation system 122 for translation into the destination language at step 127. The translated message in text form is then transmitted back to the voice recognition system 31 where it is converted by converter 31(b) to a voice message, but this time in the destination language at step 128. The translated messages, both in text and voice form, in the destination language, are then transmitted to client 2 where they are received at step 129.

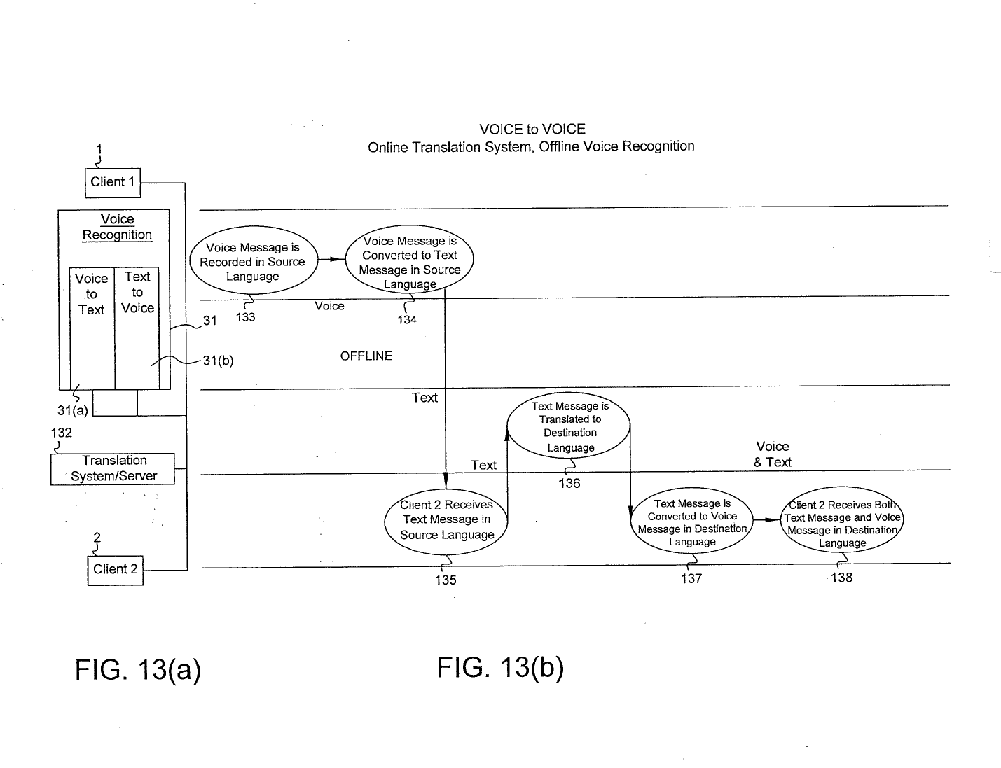

FIGS. 13(a) and 13(b) illustrate a voice to voice communication sequence between the devices client 1 and client 2 with an embedded cloud-based online translation system and an off-line voice to text converter and an off-line text to voice converter. Here, client at step 133 records a voice message in the source language and transmits the voice message to voice recognition system 31 where it is converted by converter 31(a) into a text message in the source language at step 134. The converted text message is then transmitted to client 2 which receives the text message in the source language at step 135. Client 2 then transmits the text message to the embedded cloud-based translation system 132 where it is translated into the destination language at step 136. The translated text message is then transmitted to the text-to-voice converter 31(b) at voice recognition system 31 where at step 137 the text message is converted to a voice message in the destination language and then transmitted in both text and voice format, in the destination language, to client 2 which receives it at step 138.

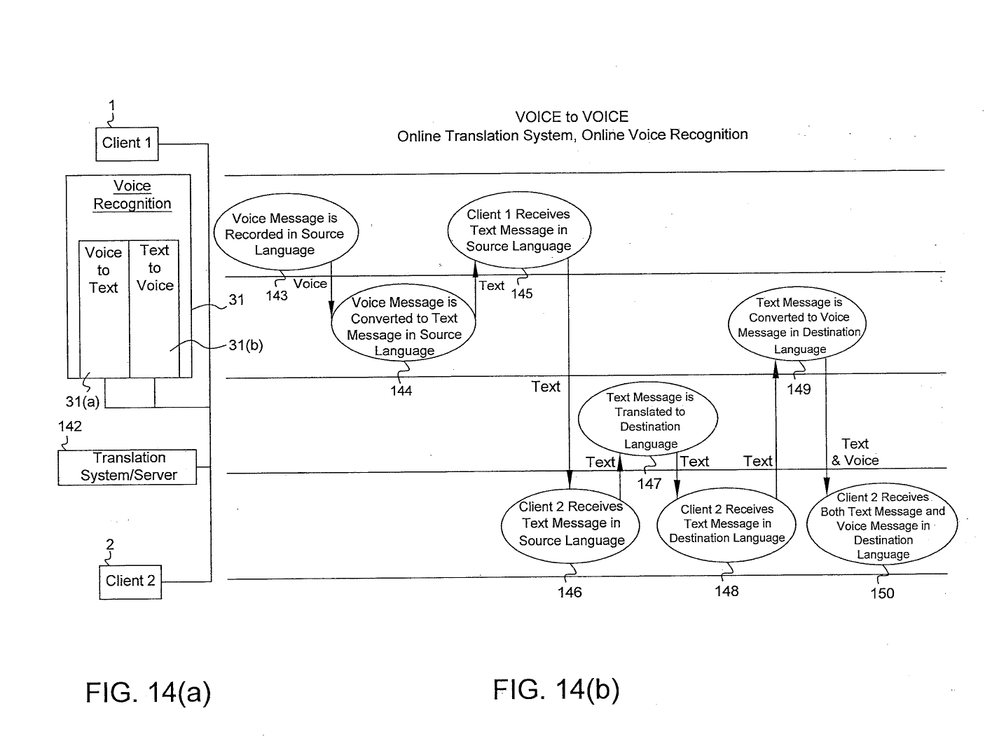

FIGS. 14(a) and 14(b) represent a voice to voice communication sequence between client 1 and client 2 using an embedded cloud based online translation system and a cloud based voice recognition system with both a voice-to-text converter and a text-to-voice converter. In this sequence, a voice message is recorded at client 1 in a source language at step 143 and transmitted to online voice recognition system 31 where the voice-to-text converter 31(a) converts the voice message to a text message in the source language at step 144. The text message is then transmitted to client 1 which receives it at step 145. The text message is then retransmitted to client 2 which receives it step 146. The text message is transmitted to translation system 142 where at step 147 it is translated into the destination language in text format. The text translation is transmitted to client 2 which receives it at step 148 in the destination language and then transmits it to voice recognition system 31 where it is converted by the text-to-voice converter 31(b) into a voice message in the destination language at step 149. Client 2 receives the translated and converted text and voice messages in the destination language at step 150.

In order to process the various sequences authorization is required. Authorization is completed by sending in http or https request containing a user's phone number and a unique device ID (smart phone) to a server.

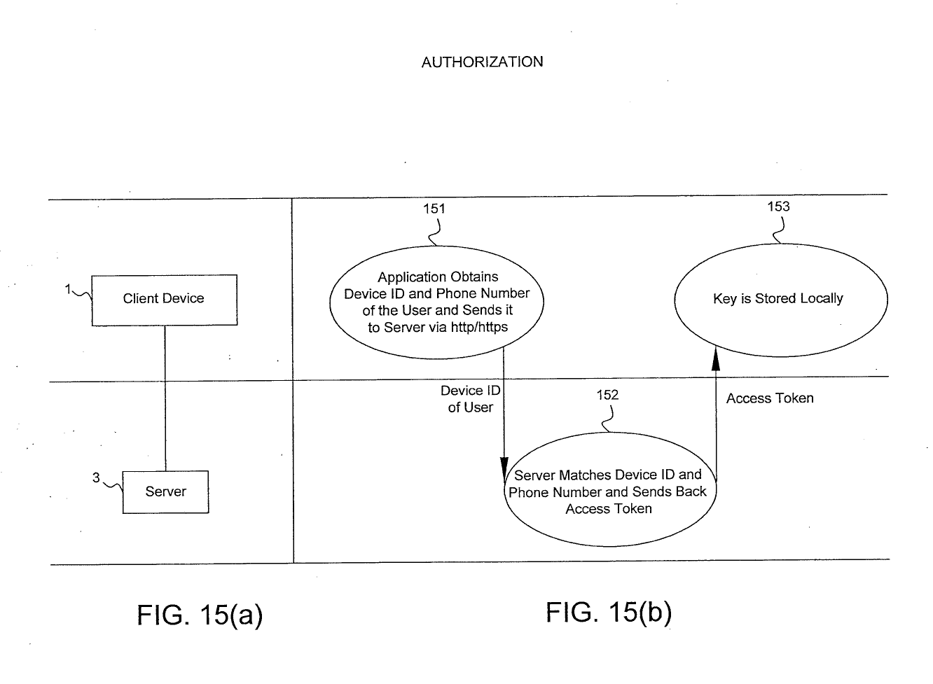

FIGS. 15(a) and 15(b) illustrate authorization. As illustrated, a client device such as client 1 is connected to a server 3. An application at the client device obtains a device ID and a phone number of the user at step 151 and transmits them to the server 3 via http/https. At step 152, the server matches the device ID and the phone number and sends back an access token or key which is required for access to the server, and the token or key is stored locally at client 1, step 153.

Users exchange messages via an XMPP protocol (or other similar method). Received messages are locally stored on the client device for subsequent display. If the user enables a translation of messages for a displayed dialog, then all incoming messages are translated into the language specified by the user.

As noted above, text and voice based messaging is a communication technique where textual character strings and voice recordings can be sent and received as translated messages.

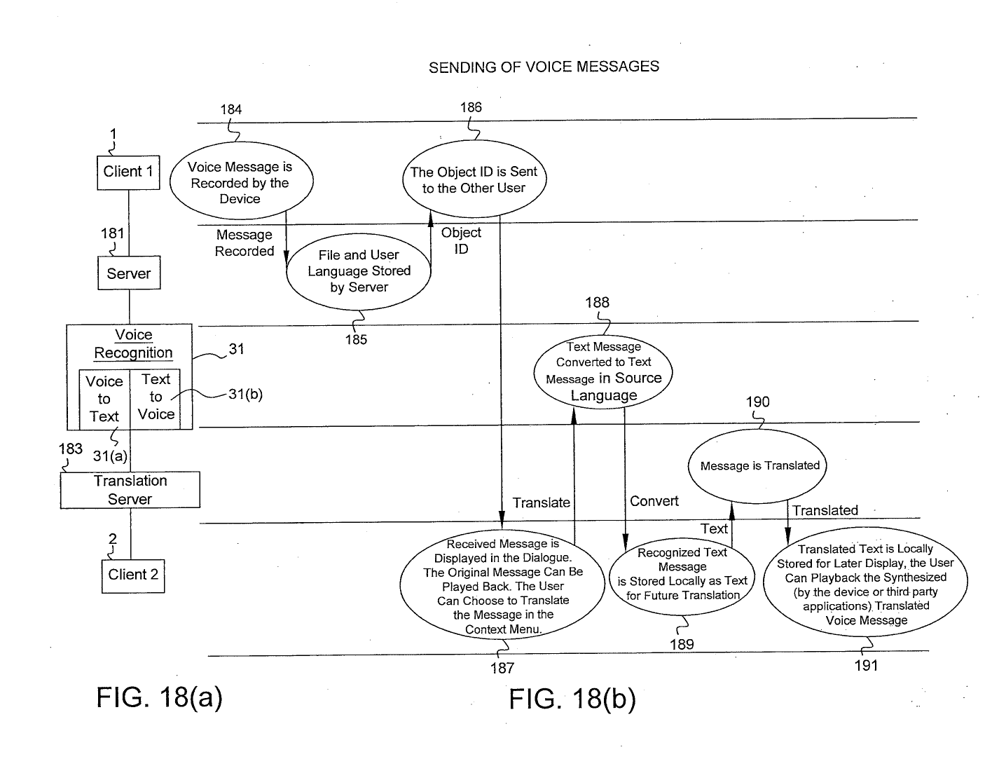

Sending a voice message is illustrated at FIGS. 18(a) and (b). Here, client 1 is connected to a server 181 which is connected to a voice recognition system 31 which in turn is connected to a translation server 183 connected to client 2. To send a voice message, the voice message is recorded at the client 1 device, step 184, and then transmitted to server 181 where it is filed and stored, step 185. An object ID is then sent to the second client device, client 2, at step 186. The received message is then displayed in a dialog at client 2, step 187, and the original message can be played back. The user can then choose to translate the message in a context menu. To do so, client 2 transmits the voice message to voice-to-text converter 31(a) of voice recognition system 31 where it is converted to a text message in the original source language at step 188. The recognized text message is locally stored as text for future translation at step 189. The message can then be translated by translation server 103 at step 190 and can then be locally stored by client 2 for later display. The user can use text-to-voice converter 31(b) of voice recognition system 31 and play back the translated voice message, step 191.

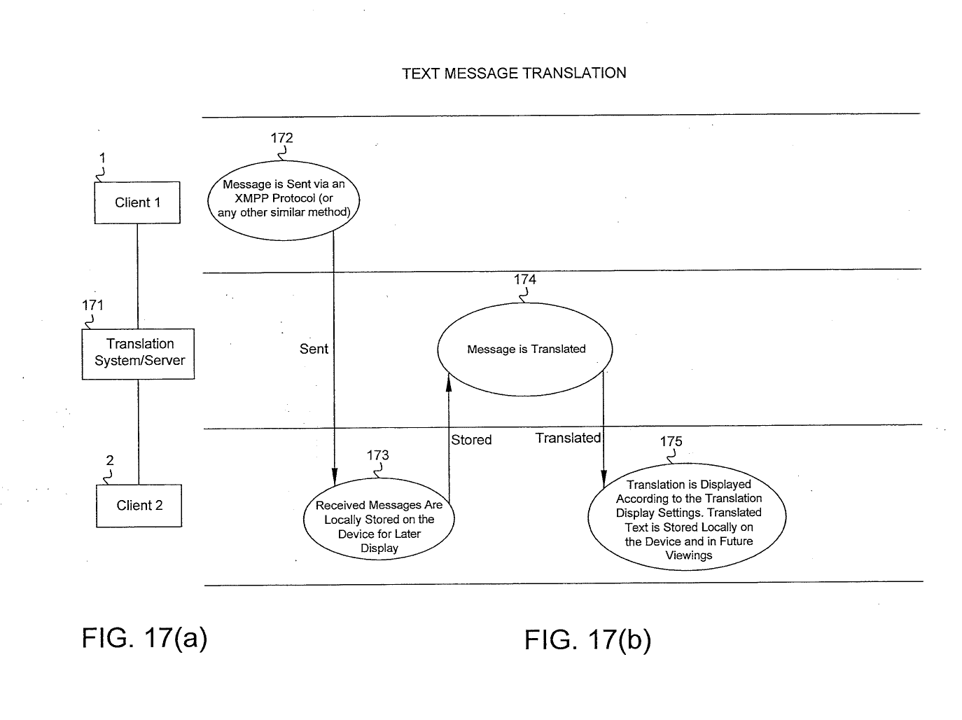

Translation of a text message is illustrated at FIGS. 17(a) and 17(b). At step 172 a text message can be sent to client 2, via an Extensible Messaging and Presence Protocol (XMPP) (a communications protocol for message-oriented middleware based on XML (Extensible Markup Language) which enables the near-real-time exchange of structured yet extensible data between any two or more network entities. When received at client 2, the message can be locally stored for later display at 173.

The message can then be translated by translation server 171, step 174 and then at step 175 displayed according to the translation display setting. Parameters for translations such as source language, target language and text, are provided to the translation service/server. Translated text is also stored locally on the client device for future viewing. The user can playback the synthesized (by the device or third party applications) translated voice message.

Users exchange messages via an XMPP protocol (or any other similar method). Received messages are locally stored on the device for later display. If the user enables translation of messages for displayed dialogue then all incoming messages are translated into the language specified by the user.

If a message was already translated, then, depending on the display preferences, either translated message, or both original and translated message can be displayed. In the event of an error, original text of the message and error icon will be displayed. The time of translation attempt is stored on the device. During future viewings of the message, the program will try to translate it again if two days have passed since the last unsuccessful attempt.

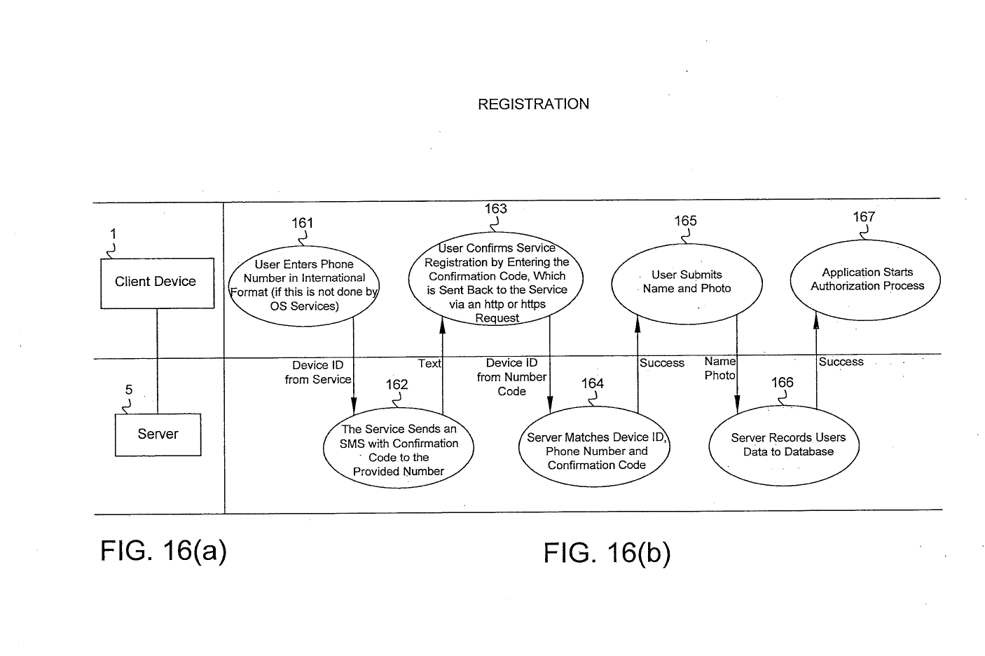

As illustrated in FIGS. 16(a) and 16(b), registration of a device is accomplished by a user entering at step 161 a phone number, in an international format, if not already done by the operating system (OS service) at the client device 1. The client device transmits a Short Message System (an SMS) with a confirmation code to the provided phone number at step 162 and at step 163 the user confirms registration by entering a confirmation code which is sent back to the service via an http or https request. At step 164, the server matches the device ID, the phone number and the confirmation code. At step 165, the user submits to the client a name and photo where at 166 the server records the user's data to a database. Hereafter, the application begins an authorization process at step 167.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. A computer based method for translation and communication of messages, comprising sending a message in a source language using a transmission protocol from a first client device to a second client device, transmitting by either said first or second client device said source language message using a transmission protocol to a translation server for translating said message from said source language to a destination language, displaying said message in its destination language, and storing said message in its destination language, said translation server being either on-line or off-line.

2. The method according to claim 1, wherein said protocol is XMPP (Extensible Messaging and Presence Protocol).

3. The method according to claim 1, wherein said message is transmitted to said second client device prior to translating said message.

4. The method according to claim 1, wherein said message is a text message.

5. The method according to claim 4, further comprising converting said text message to a voice message using either an on-line or off line text-to-voice converter after translation of said message from its source language to the destination language.

6. The method according to claim 4, further comprising converting said text message to a voice message using either an on-line or off line text-to-voice converter prior to translation of said message from its source language to the destination language.

7. The method according to claim 3, wherein said message is a text message which is converted to a voice message using either an on-line or off line text-to-voice converter after translation of said message from its source language to the destination language.

8. The method according to claim 1, wherein said message is a voice message.

9. The method according to claim 8, further comprising converting said voice message to a text message prior by a voice-to-text converter to translating said message from its source language to its destination language.

10. The method according to claim 9, wherein said source language message is transmitted to said voice-to-text converter by said first client and then transmitted back to said first client after conversion to a text message in the source language, said converted text message then being forwarded to said second client, further comprising the steps of transmitting said converted text message to a translation server for translation to a destination language, transmitting said translated text message from said translation server to a text-to-voice converter which converts the translated text message to a voice message in the destination language, and said translated text message and said translated voice message both in the destination language being forward to said second client.

11. The method according to claim 1 further comprising registering a device by a user.

12. The method according to claim 11 wherein said step of registering comprises entering a user telephone number which is forwarded to a server, transmitting by said server to said entered telephone number a confirmation code, confirming registration by said user.

13. The method according to claim 12 wherein said confirming registration by said user comprises user entering the confirmation code for transmission to the server via an http or https request, matching a device ID, the telephone number and the confirmation code and confirms same to the user and records same in a database.

14. The method according to claim 13 further comprising authorizing a user by having the user enter and transmit said device ID and telephone number via http or https to a server for matching by said server to a previously resisted user, and returning to said user an access key.

15. A system for effecting a method for translation and communication of a message in a source language, comprising a computer having software for transmission of said message, a translation server connected to or in communication with said computer for translating said message from its source language to a destination language, a first client connected with said computer and said translation service for initiating a message to be transmitted to a second client and/or to said translation server.

16. The system according to claim 15 further comprising a text-to-voice converter connected or in communication with said computer and/or with said first client and/or with said second client for converting a text message to a voice message for transmission to said second client.

17. The system according to claim 15 further comprising a text-to-voice converter connected or in communication with said computer and/or with said first client and/or with said second client for converting a text message to a voice message for transmission to said second client, and a voice-to-text converter connected with said computer, and/or said translation server and with said first and/or said second client for converting said voice message to a text message.
